(19) United States
(12) Patent Application Publication
(10) Pub. No.: US 2007/0025600 A1
(43) Pub. Date: Feb. 1, 2007

(54) Printer with fingerprint identification function

(75) Inventor: Michael Ghebreyesus, Los Angeles, CA (US)

Correspondence Address: Michael Ghebreyesus, 178 1/2 South Sycamore Street, Los Angeles, CA, 90036, US

(73) Assignee: Berendo Solutions, Inc., Los Angeles, CA (US)

(21) Appl. No.: 11/190,692

(22) Filed: Jul. 26, 2005

(51) Int. Cl. G06K 9/00

(52) U.S. Cl. 382/124; 340/5.83

(57) ABSTRACT

A mobile or handheld printer incorporates fingerprint recognition. The mobile printer is a part of a larger system that accesses secure and controlled access databases containing confidential information such as the history of an individual. The mobile printer and the larger system can use a recognized fingerprint to identify an individual in real time. A report or citation can be also printed in real time, while municipal or private databases are modified to reflect the subject activity of the report or citation.

### FIELD OF THE INVENTION

The present application is generally related to technology for identifying people, and more specifically related to determining information on an individual from secure databases based upon fingerprint identification of that individual.

### BACKGROUND OF THE INVENTION

Properly identifying an individual is more important than ever, particularly after the events of September 11. This is true not only for law enforcement activities but also for various activities that require authorization before access can be granted.

In law enforcement, it is advantageous to be able to determine and/or verify a person's identity in real time. For instance, a police officer or other government official such as an immigration official would greatly benefit from the ability to quickly and easily verify the authenticity of an identity card or passport.

Numerous other activities, in either the private sector or the government, involve access to confidential data. Properly identifying an individual in real time before providing such access is critical.

### SUMMARY OF INVENTION

The present invention includes both systems and methods for rapidly identifying a person with a mobile device. In an embodiment that incorporates a wireless connection, a person can be identified in real time in the field in virtually any location. With the authorization, numerous other things can be determined nearly instantly. Based upon this information, action can be taken immediately, without hesitation or loss of time. The action can vary greatly depending on the application of the system and method. For example, in a law enforcement scenario the action may include issuing a citation or detaining an individual. In another scenario, the action may include authorizing a person to view highly confidential data and tracking the person's activities.

One aspect of the present invention is a method of identifying an individual. The method comprises providing a handheld wireless device comprising a printer and a fingerprint reader, capturing the individual's fingerprint with the device, accessing a database of fingerprints, comparing the captured fingerprint with stored fingerprints in the database of fingerprints, and identifying the individual based upon the comparison. The method may further comprise accessing a database of warrants or wanted persons and determining if there is a warrant for the identified individual or if that person is wanted. It may also further comprise accessing a database of authorized personnel and determining if the person is authorized to access secure information or areas. It may also further comprise accessing a database containing information on moving violations and inputting information on a moving violation of the identified individual into the database.

Another aspect of the present invention is a system for identifying a person. The system comprises a mobile device that intern comprises a fingerprint scanner, microprocessor, and a wireless transceiver. The mobile device is for use with a municipal computer network comprising confidential limited access databases. The system also comprises a proxy server that accesses information from the confidential limited access databases located in secure servers in the municipal computer network, wherein the proxy server is located outside of the municipal network, and wherein the proxy server transmits information to and from the mobile device.

### BRIEF DESCRIPTION OF THE DRAWINGS

FIG. 1 is a diagram of system 100 illustrating an embodiment of the present invention.

FIG. 2 is an illustration of a preferred usage of system 100.

FIG. 3 is a front view of handheld device 110.

FIG. 4 is a rear view of handheld device 110.

FIG. 5 is a schematic illustration of the major components of handheld device 110.

FIG. 6 illustrates citation processing screen 200A according to a preferred embodiment.

FIG. 7 illustrates processing screen 200B according to a preferred embodiment.

### DETAILED DESCRIPTION OF THE PREFERRED EMBODIMENTS

The present invention provides for positive identification of individuals based upon one or more fingerprints. This is preferably done with a portable handheld device. This identification can thereafter be used for various purposes in a myriad of scenarios. One particular scenario where such identification is well suited is in law enforcement. Another particular environment is in verification and authorization, whether it be for retail transactions or to allow access to other sensitive, confidential or limited-access information.

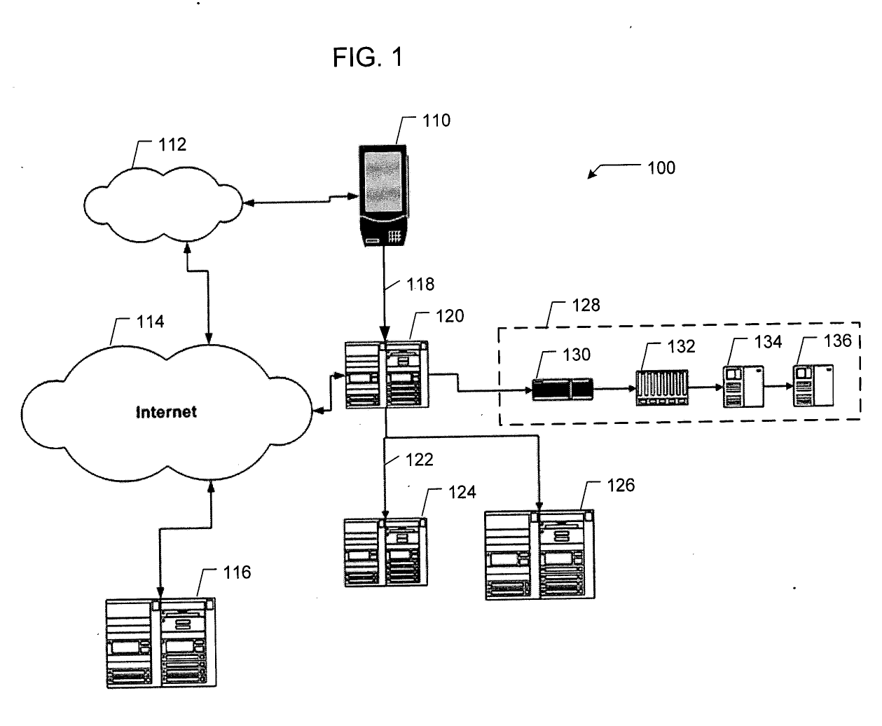

A preferred embodiment relating to law enforcement will now be described with reference to FIGS. 1-7. It should be understood that the present invention is not limited to the embodiments described and that different embodiments may involve a different system or back-end as will be understood by those of skill in the art to be within the appended claims. FIG. 1 illustrates system 100. In system 100, mobile device (“MD”) 110 is used to access certain restricted read only databases, and to write to other databases. In the field of law enforcement, a police officer, for instance, carries MD110 in the field. Mobile device 110 comprises a fingerprint scanner, as will be described in more detail later. Various other municipal officials could also carry and use MD 110. Municipal is meant to have its ordinary meaning: of or relating to the internal affairs of a major political unit such as local, state, or national government.

In other fields, MD 110 could be carried by any person responsible for identifying and/or authorizing a transaction, activity, or access. For example, it could also be used by a sales person or bank representative to allow access to secure databases such as those of credit card companies or banks. In another example, MD 110 could be employed by agents allowing ingress or egress from the country, a secure building, airplane, train or the like. Similarly, it could be used to gate access to secure computer databases with or without the use of an administrator.

MD 110 is connected to the Internet 114 or other wide area network 114 via a wireless connection 112 such as the General Packet Radio Service (“GPRS”) network, other cellular network, or what is known as WiFi, also commonly referred to by the current 802.11b or 802.11g standards. Any number of wireless protocols, current or future, may be used for wireless connection 112. Additionally, because MD 110 is also a phone, the device can also access various cellular networks for voice or data without connecting via the Internet.

MD 110 may be connected to proxy server 120 by wired connection 118 or may connect via wireless network 112 and the Internet 114. Proxy server 120 is a logical representation and may be physically present on share server 116, record management system (“RMS) 124 or any computer. Proxy server 120 is a type of communication middleware layer that can access multiple databases. For instance, in the case of law enforcement, it would allow a user of share server 116, or MD 110 to access other servers on private network 128. The communication between proxy server 120 and private network 128 can be thought of as a type of peer to peer network, wherein proxy server 120 searches for content on private network 128 which is then retrieved by proxy server 120. Such servers may include servers within local police departments, or at the national crime information center. In general, the secure or limited access databases would contain information related to law enforcement, such as fingerprints, crime histories, judicial databases, lists of wanted people (“wants”) and warrants etc . . . Some examples of these databases are as follows: National Crime Information Center; California Law Enforcement Telecommunication System; State and Local Department of Motor Vehicles; United States Department of Motor Vehicles; California Identification; Automated Fingerprint Identification System; National Law Enforcement Telecommunication System; Automated Warrant System; Consolidated Criminal History Reporting System; Juvenile Database; No-Fly List; California Warrant System; Los Angeles Regional Crime Information System; and Missing Person Inquiry. This list is not exhaustive and only serves to provide examples of the databases that may be accessed with the present invention. These databases that are maintained by or for public safety and law enforcement will be referred to as municipal databases even though they may contain information not specifically related to a particular municipality or its operations, and are not owned and operated directly by a particular government agency. Router 130 of private network 128 controls access to these databases. Shown in FIG. 1 for illustrative purposes are Los Angeles County Judicial Information Center Hub 130, California Law Enforcement Telecommunication System (“CLETS”) 134 and National Crime Information Center (“NCIC”) 136 These need not be accessed serially as illustrated, but may each have their own connection to router 128. Generally speaking, the databases of private network 128 are read only. This is different than the databases contained in RMS 124, court systems 126 and share server 116; although these servers contain municipal databases and may physically be present within municipal buildings such as the police station or court house, these machines and the databases are both read and write accessible. These machines/databases are used for recording information about citations and issuing the citations. Therefore they are accessible for read/write operations from proxy server 120 and MD 110.

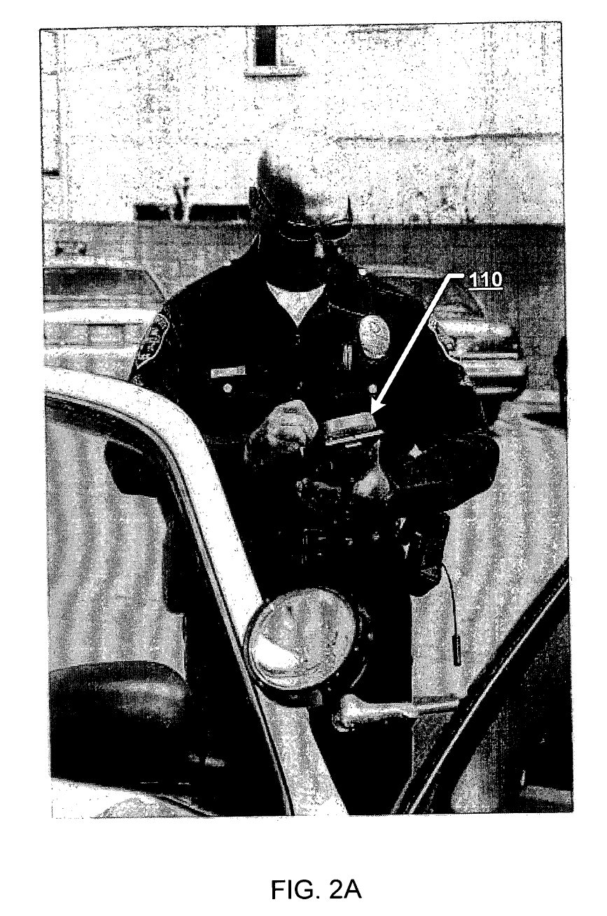

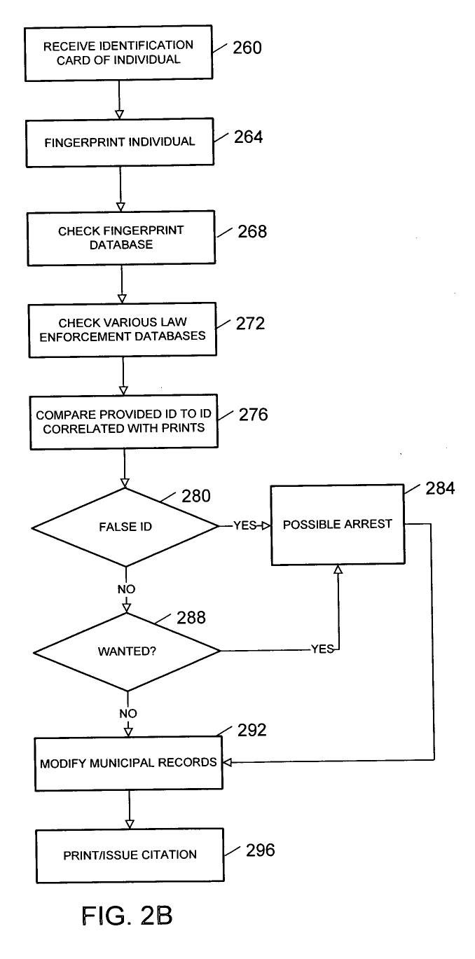

As seen in FIGS. 2A and 2B a police officer can use both MD 110 and system 100 to identify an individual and eventually issue a citation. FIG. 2B describes some of the various steps involved in the process. In step 260 the officer receives the identification card (driver's license, passport, electronic badge etc . . . ) of the individual. In step 264 the officer fingerprints the individual with MD 110. This involves taking one or more prints. In step 268 system 100 checks a database of fingerprints which is in private network 128. If the fingerprint(s) are in the database, the system will provide the name and whatever other personal information is available regarding the individual's identity. Next, in step 272, system 100 checks various other available law enforcement databases. This will indicate, for instance, if the individual is wanted or if there is an arrest warrant for the individual in any jurisdiction. With this information, the officer can then determine if the identification card provided by the individual is false or accurate, as seen in steps 276 and 280. If the individual is wanted, as determined in step 288, or if the officer and/or system determine that a false identification was provided, an arrest or detention may be indicated as seen in step 284. In either case, municipal records in one or more of share server 116, RMS 124 and court systems 126 will be written to and a citation generated in the system in step 292. A paper copy of the citation is then printed and issued on the spot with MD 110, as seen in step 296.

This system allows authorities to instantly verify the identity of the suspect without ever having to go back to a patrol car or office, or even without ever having to turn their back on a potential suspect. Those in the law enforcement field appreciate the ability to gather such valuable information without taking an eye off of a potentially dangerous individual or flight risk.

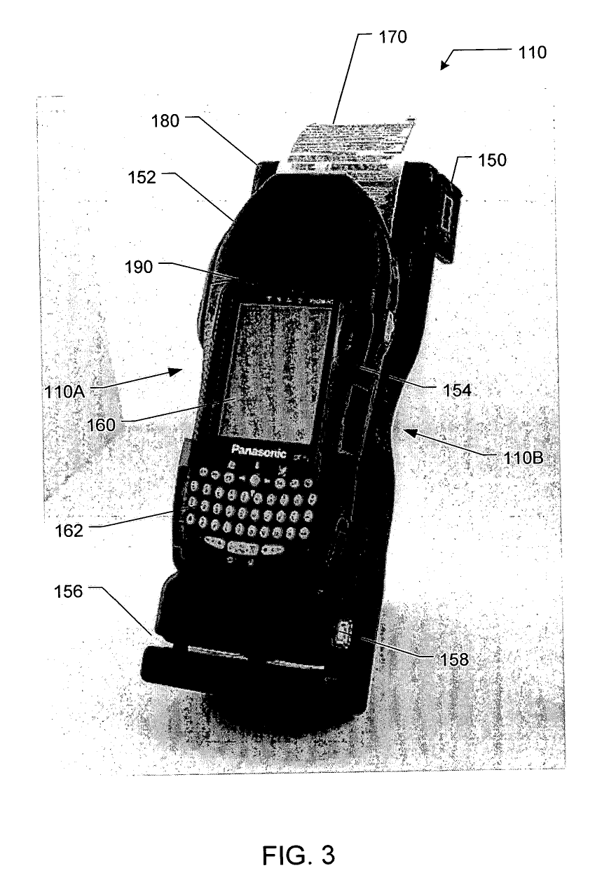

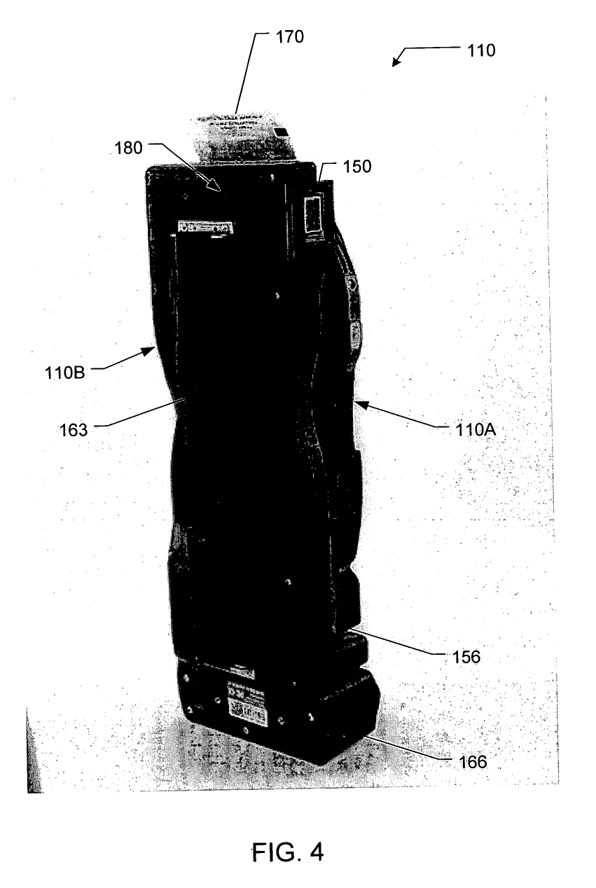

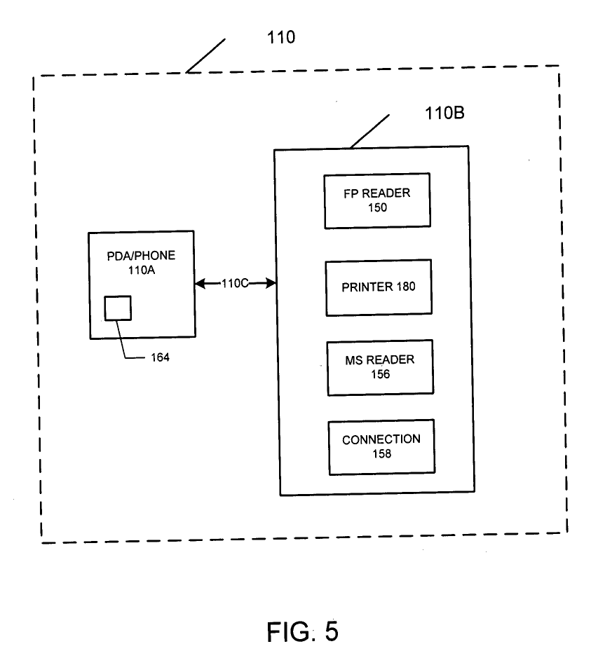

FIGS. 3 and 4 are perspective views of MD 110. FIG. 5 is a schematic illustration of MD 110. In a preferred configuration MD 110 comprises two pieces, PDA phone 110A and printer cradle 10B. In another embodiment all components are integrated in one single piece. MD 110 printer cradle 110B comprises a printer 180 that prints citations 170, fingerprint reader 150, magnetic stripe reader 156 and connector 158. Connector 158 may be any common type of connector such as Ethernet or USB. PDA phone 110A comprises display 160 and input 162 including a keyboard and stylus used to write on display 160, which is also an input device. PDA phone 160 further comprises speaker 190, microphone 154 and GPS unit 152. Strap 163 enables MD 110 to easily be carried by a user. Bar code reader 166 can be used to read bar codes for any number of reasons, and provides instant access to the information contained in any bar code. This information can be stored in memory and correlated with any other pertinent information entered into the system. Bar code reader 166 is preferably a 2D reader but can also be of another configuration such as 3D. MD 110 also comprises a processor, storage including flash memory, random access memory and/or a hard disk (all not shown), and a transceiver 164 for sending and receiving voice and data.

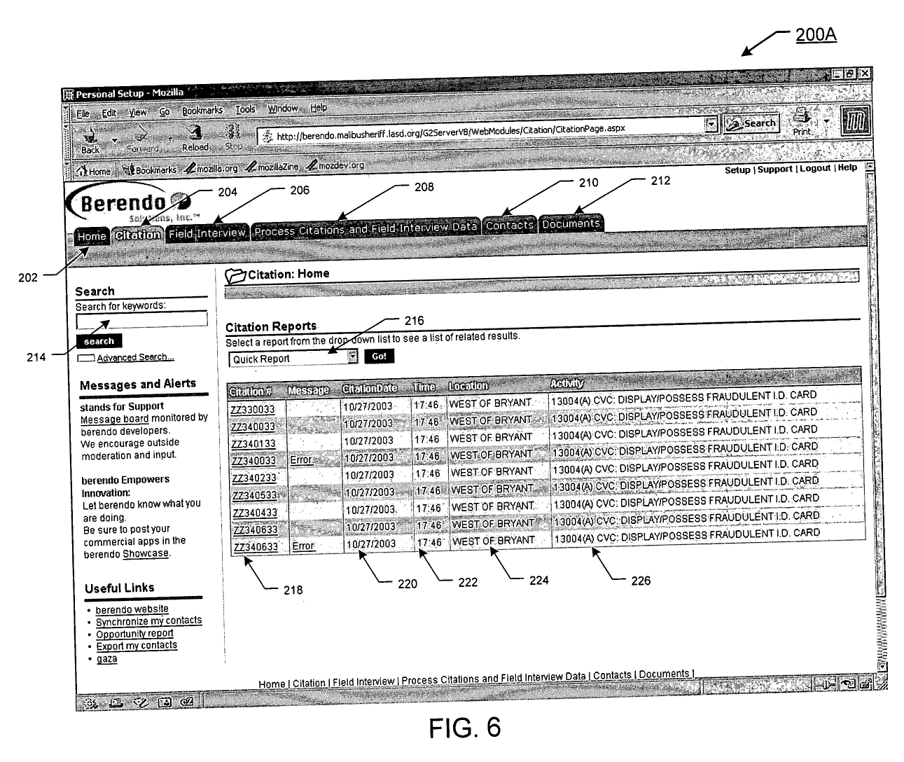

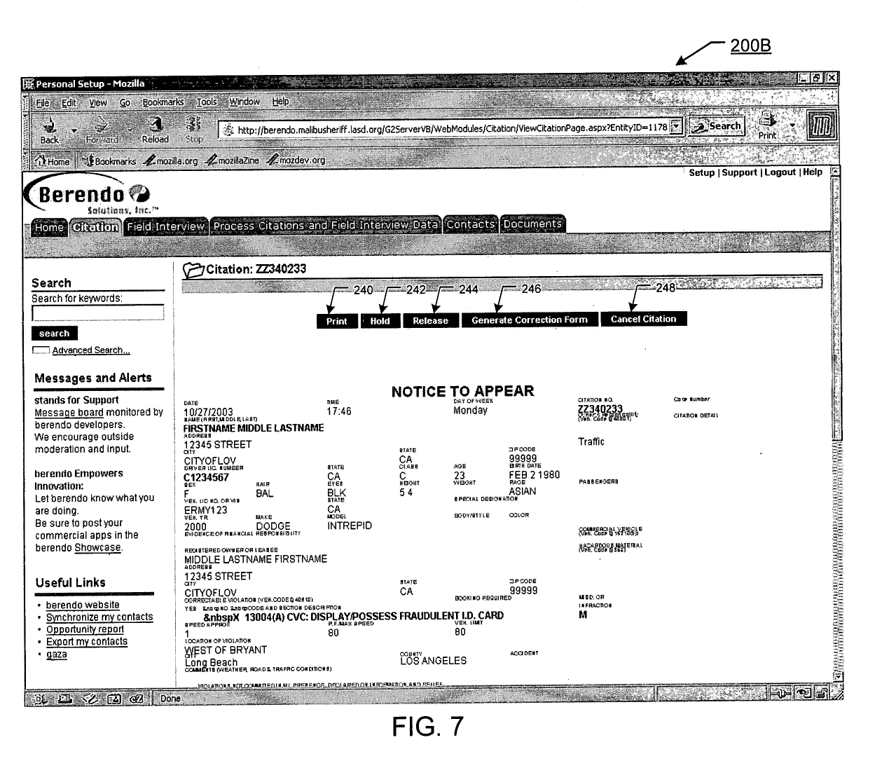

FIGS. 6 and 7 are user interface screens used to view and modify data stored in the many databases accessible by system 100. A user of system 100 could view such screens and create reports and files relevant to the particular task at hand. This could be done via MD 110, share server 116, RMS 124, or another computer (not shown) connected to proxy server 120 via the internet or a local network connection. Although the screens depict reports and files relevant to law enforcement, many types of reports and data manipulation can be performed. For instance, if system 100 is used for general authorization purposes, for instance to access confidential records, information pertinent to the records could be viewed and manipulated. In such an environment, system 110 also comprises usage databases, including information pertaining to all attempts to access any information. This, for example comprises information including: the user and the information sought, the time and location of the access; the authorization level of the user; the data authorized and viewed; the authorization level required to view such data; the data manipulated; and the type of manipulation such as what type of report was created or modified.

Different interface pages or interfaces allow for different data to be viewed in different formats, and different reports and data to be created and manipulated. FIG. 6 shows that interface 200A allows the user to navigate to Home Page 202, Citations Page 204, Field Interview Page 206, Process Citations and Field Interview Data Page 208, Contacts Page 210 and Documents Page 212. The user can also quickly search for specific information with a search engine accessed via search box/function 214. Various types of reports can automatically be generated by selecting from a list of pre-made reports with drop down report selector 216. System 110 also allows for customization of the various types of reports that can be selected via report selector 216. Depending on the format selected, different information will be displayed. The “quick report” citation format includes column 218 for the citation number, column 220 for the citation date, column 222 for the citation time, column 224 for the location of the citation, and column 226 for characterization of the citation or a related activity that took place at the time of the citation.

FIG. 7 illustrates a notice to appear being prepared with system 100. Various functions are available during viewing and creation of the notice. A user of the system may print the notice with print function 240, hold the notice with hold function 242, release the notice with release function 244, generate a correction form with function 246, or cancel the citation with cancel function 248.

The aforementioned interfaces and embodiments are illustrative only, and will, of course, vary depending on the usage environment and specific type of data to be manipulated. It should be understood that the present invention is not limited to those embodiments, scenarios, and interfaces described, but is defined by the appended claims.

It is claimed:

1. A method of identifying an individual, comprising:
providing a handheld wireless device comprising a printer and a fingerprint reader;
capturing the individual's fingerprint with the device;
accessing a database of fingerprints;
comparing the captured fingerprint with stored fingerprints in the database of fingerprints; and
identifying the individual based upon the comparison.

2. The method of claim 1 further comprising:
accessing a database of warrants; and
determining if there is a warrant for the identified individual.

3. The method of claim 1 further comprising:
accessing a database of wanted persons; and
determining if the individual is wanted.

4. The method of claim 1 further comprising:
accessing a database of authorized personnel; and
determining if the person is authorized to access secure information or areas.

5. The method of claim 1 further comprising:
accessing a database containing information on moving violations; and
inputting information on a moving violation of the identified individual into the database.

6. The method of claim 5 further comprising issuing a citation to the individual.

7. The method of claim 6 wherein issuing the citation comprises printing the citation at the site of the violation, using the device.

8. The method of claim 6 wherein issuing the citation comprises updating municipal records.

9. The method of claim 1 further comprising verifying that a driver's license provided by the individual correlates with stored information in a database of driver's license information.

10. A method of identifying an individual, comprising:
capturing the individual's fingerprint with a mobile printer, the mobile printer having a processor and access to the Internet;
accessing a database of fingerprints via the Internet;
comparing the captured fingerprint with the accessed database of fingerprints; and
identifying the individual based upon the comparison.

11. The method of claim 10 wherein access is provided by a wireless connection.

12. The method of claim 10 wherein access is provided by a wired connection.

13. The method of claim 10 further comprising comparing the identified individual to a database of authorized individuals.

14. The method of claim 13 further comprising authorizing the individual if the comparison yields a match.

15. The method of claim 14 further comprising transmitting the authorization to a database.

16. A system for identifying a person, comprising:
a mobile device comprising a fingerprint scanner, microprocessor, and a wireless transceiver,
the mobile device for use with a municipal computer network comprising confidential limited access databases; and
a proxy server that accesses information from the confidential limited access databases located in secure servers in the municipal computer network, the proxy server located outside of the municipal network,
wherein the proxy server transmits information to and from the mobile device.

17. The system of claim 16, further comprising a record management system that receives information from the proxy server and stores the information.

18. The system of claim 17, wherein the information stored in the record management system comprises information associated with violations.

19. A system for identifying a person, comprising:
a mobile device comprising a fingerprint scanner, microprocessor, and a wireless transceiver,
the mobile device for use with a protected computer network comprising confidential limited access databases; and
a proxy server that accesses information from the confidential limited access databases located in the protected computer network, the proxy server located outside of the protected computer network,
wherein the proxy server transmits information to and from the mobile device.
